(19) United States
(12) Patent Application Publication
(10) Pub. No.: US 2008/0253389 A1
(43) Pub. Date: Oct. 16, 2008

(54) Method and System of Radio Communications With Various Resolution Levels of Signal Modulation Depending on Propagation Conditions

(76) Inventor: Peter Larsson, Solna (SE)

Correspondence Address: ERICSSON INC., 6300 LEGACY DRIVE, M/S EVR 1-C-11, PLANO, TX, 75024, US

(21) Appl. No.: 11/577,226

(22) PCT Filed: Oct. 15, 2004
(86) PCT No.: PCT/SE04/01490

§ 371 Date: Feb. 7, 2008

(51) Int. Cl. H04L 29/02; H04J 13/00

(52) U.S. Cl. 370/441; 370/431

(57) ABSTRACT

The present invention relates to communications. More especially it relates to multiple access communications over channels of diverse channel qualities, e.g. signal to noise and interference ratios. Particularly it relates to data communications over radio links with diverse propagation path losses and exploitation of diverse path losses for multiplexing and multiple access purposes. The present invention discloses multiplexing of users or channels in a communications system, particularly a multi-resolution system, where users are allocated different respective resolution levels depending on propagation conditions.

### TECHNICAL FIELD OF THE INVENTION

The present invention relates to communications. More especially it relates to multiple access communications over channels of diverse channel qualities, e.g. signal to noise and interference ratios. Particularly it relates to data communications over radio links with diverse propagation path losses.

### BACKGROUND AND DESCRIPTION OF RELATED ART

Multi-resolution modulation and coding is previously known. When e.g. images are communicated, it is previously known to use multi-resolution modulation and coding to achieve a system capable of transmitting images to be received at various resolutions in terms of pixels, pixels per inch or dots per inch.

From prior art is also known various methods and systems for multiplexing a plurality of users or user channels in a medium of limited capacity, such as FDM (Frequency Divisions Multiplex), TDM (Time Division Multiplex) and CDM (Code Division Multiplex). According to prior art, users are multiplexed by dividing an entire bandwidth resource into channels or channel resources characterized by orthogonality in frequency, time and code domain, respectively. Also known in prior art are multiplexing systems combining two or more of FDM, TDM and CDM thereby achieving channels or channel resources characterized by orthogonality in two or more domains, e.g. time and frequency domain.

U.S. Pat. No. 5,581,578 discloses multi-resolution QAM signal constellations and demonstrates recursively and adaptively increased resolution from sub-constellations.

European Patent Application EP0731588 reveals multi-resolution modulation with (coarse resolution) four phase modulation, where multi-resolution is achieved by binary modulating also amplitude for increased resolution.

International Patent Application WO03065635 suggests a method of operation for single-user spread OFDM wireless communication with successive interference cancellation algorithm for retrieval of transmitted information thereby increasing reliability of the estimate achieved. The received signal is decoded by successively splitting the received signals into an increased number of portions, canceling interference by subtracting earlier detected portions from the received signal.

R. H. Morelos-Zaragoza, M. P C. Fossorier, S. Lin, H. Imai: ‘Protection and Multistage Decoding,’ 1998 and 1999, describes in Part I Symmetric Constellations. Part II Asymmetric Constellations describes error performance of multi-level block coded modulation for unequal error protection and multistage decoding. Most significant information is associated with “clouds” of sequences and less significant information is associated with individual sequences within the clouds.

K. Ramchandran and M. Vetterli: ‘Multiresolution Joint Source-Channel Coding for Wireless Channels’, January 1998 describes multi-resolution source coding, multi-resolution channel coding, and joint source-channel coding. Multi-resolution QAM and SNR scalability are described in some detail. SNR scalability is a spatial domain method where channels are coded at identical sample rates, but with differing picture quality (through quantization step sizes). The higher priority bit stream contains base layer data to which a lower priority refinement layer can be added to construct a higher quality picture.

A. Seeger: ‘Multiresolution Joint Source-Channel Coding for Wireless Channels,’ January 1998 suggests a clustered signal constellation of eight diamonds, each of four signal points, thereby forming 32-Diamond constellation. Each diamond or cluster of four signal points is determined by its phase. The eight different phases represent 3 bits. Each of the four signal points within a diamond is then identified by two binary decisions, each representing 1 bit.

None of the cited documents above discloses multi-resolution multiplexing of users or channels in a communications system, where users are allocated different respective resolution levels depending on propagation conditions.

### SUMMARY OF THE INVENTION

A general problem of multi-user systems is providing a sufficient number of communications resources to enable a great number of users to access the communications system without interfering.

State of the art multiplexing techniques such as TDMA, FDMA or CDMA offer limited spectrum efficiency as number of users that are enabled increases linearly with sub-division of the communications resource. Typically, a single user may use 1-2 bits/Hz/s per cell or sector of a cellular mobile telecommunications system. Particularly, with limited radio spectrum available there is a need for spectrum efficient multiplexing.

Consequently, there is a need of providing channel resources by further sub-dividing a common communications resource without causing excessive interference between users' individual communications.

It is consequently an object of the present invention to achieve a communications system providing increased number of user channels.

A further object is to achieve spectrum efficient multiplexing.

It is also an object to achieve a system of interference cancellation, canceling interference from other users' communications.

Another object is to provide a demodulator incorporating interference cancellation.

Finally, it is an object to categorize users perceiving good and bad propagation properties respectively and allocating and multiplexing users accordingly.

These objects are met by a method and system of transmission power multiplex, multiplexing users by allocating various transmission power levels, in the sequel referred to as multi-level multiplexing.

### BRIEF DESCRIPTION OF THE DRAWINGS

FIG. 1 illustrates basic transmitter and receiver operations according to the invention.

FIG. 2 illustrates a flow chart with basic functional processing steps of a method according to the invention.

FIG. 3 illustrates a flow chart including additional processing steps of a method according to the invention.

FIG. 4 illustrates a QAM multi-resolution signal constellation with three resolution levels.

FIG. 5 illustrates a preferred signal constellation with balanced asymmetries or clustering, for the same example number of levels and signal alternatives as in FIG. 4.

FIG. 6 illustrates a communications situation with a signal constellation similar to that of FIG. 5, but extended to four levels.

FIG. 7 illustrates schematically decoding performance in terms of bit error rate or block error rate for various resolution levels versus distance between transmitter and receiver stations.

FIG. 8 schematically illustrates feedback of channel quality information according to the invention.

FIG. 9 illustrates transmitting side of system architecture for MRM with K data flows.

FIG. 10 illustrates receiving side of a system architecture of MRM for retrieving data of an i:th out of the K data flows illustrated in FIG. 9.

FIG. 11 illustrates a second embodiment of the invention. Radio coverage area is divided into two or more sectors via orthogonal multiplexing technique, e.g. TDM, FDM or CDM.

FIG. 12 illustrates an embodiment with multiple antennas on transmitter side, receiver side or both.

### DESCRIPTION OF PREFERRED EMBODIMENTS

According to the invention multiple data streams are multiplexed within the same bandwidth by means of assigning power levels in relation to path gains from a sending station to various receiving stations. One example embodiment implements joint power and rate allocation.

The multiplexed signal is sent from a transmitting station, TX, and received by a designated receiving station, RX. If the communications system is a radio communications system, for downlink transmissions the transmitting station is typically a radio base station and the receiving station is user equipment of the radio communications system.

Each receiving station, RX, is preferably capable of optimized multi-level multiplexing decoding. However, receiving stations operating at a single level need not be capable of multi-resolution decoding if properly multiplexed to a particular level, given sufficient number of available resources of its level. Each receiving station decodes its designated data from the multi-level multiplexed symbol sequence. According to one mode of the invention, assisting channel quality information, CQI, e.g. path loss or path gain, adapts the multiplexing assignments and scheduling of subsequent data. Running updates keep the channel quality information up to date.

Various embodiments according to the invention distinguish the multi-level multiplexed users somewhat differently. According to a first embodiment users allocated different power levels may be assigned different levels of multi-resolution modulation, MRM. According to other embodiments multi-level multiplexing is combined with DS-CDMA, turbo-coded CDMA, TDMA or FDMA for access of a further sub-divided communications resource.

A feature of MRM is partitioning of signal constellation providing intra-subset distance decrease with resolution level increase.

Another feature is backward compatibility. A system employing one modulation type can be extended with MRM while retaining the earlier signal set at its coarsest resolution level.

Different decoder realizations makes use of multi-user detection, MUD, including successive interference cancellation, SIC, parallel interference cancellation, PIC, maximum-likelihood decoding.

According to the first embodiment, receiver stations are assigned a resolution level in MRM depending on channel quality or path loss. A great path loss reduces received signal level and quality. The greater the path loss, the coarser the resolution level of MRM allocated. Particularly, long term transmission power control, to compensate for slow fading, can generally be replaced by proper level allocation. Scheduling transmissions of users perceiving opportune short intervals of good channels, with an instantaneous or peak CQI above average CQI, which is frequently the case for communications over channels subject to fading (causing the received signal to be subject to fading), allows the transmitter to either use less power or increase the data rate. A multi-user diversity gain is achieved due to the system being rendered available to a greater number of users.

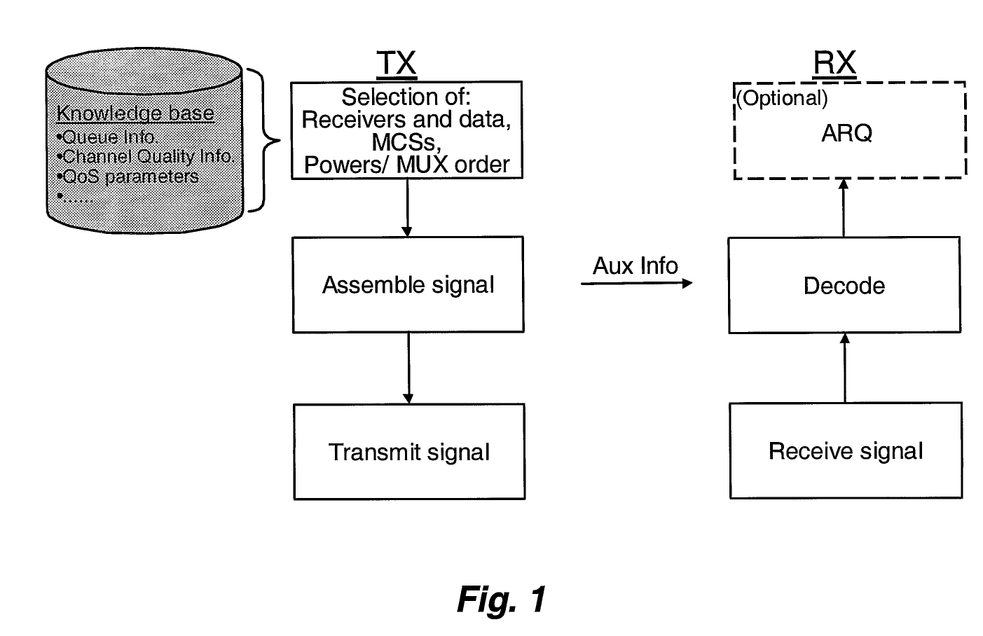

FIG. 1 illustrates basic transmitter and receiver operations according to the invention. Stored parameters in memory or other storage medium <<Knowledge base>> are input to the transmitter <<TX>>. The stored parameters contain at least some information on queue lengths, channel quality and preferably also QoS (Quality of Service) parameters for various user data flows. Based on the stored parameters, the transmitter <<TX>> can select, e.g., which receiver <<RX>> to send to and which of one or more categories of data to send, e.g. whether packet or circuit switched data should be sent. The transmitter <<TX>> also makes a selection of appropriate modulation and coding scheme, and multiplexing order or transmission power level depending on the stored parameters. Prior to transmission a signal according to the selected format is assembled <<Assemble signal>>. The assembled signal is transmitted in selected frequency range by transmit circuitry <<Transmit signal>>, e.g. high frequency radio circuitry. The receiver <<RX>> decodes <<Decode>> the composite multiplexed signal and extracts intended data. To facilitate decoding, the receiver can be informed on assembled signal configuration <<Aux Info>>, e.g. regarding modulation and coding, transmission power or multiplexing. However, decoding could also be performed blindly. Addressing is signaled through inband signaling and detected by the blind decoding. Depending on QoS requirements (robust or non-robust transmission), ARQ (Automatic Repeat Request) can optionally be included to increase reliability by retransmission of incorrectly decoded data.

Preferably, the invention is based on multi-resolution modulation, MRM, exploiting different resolution levels of a signal constellation. However, this is not a requirement. It could as well be based on, e.g., DS-CDMA or Turbo-coded CDMA. However these do not as such include a signal constellation but can be set to exploit power level selection, and optionally also rate selection, at multiple resolution levels, then preferably canceling low-resolution interferer(s) prior to decoding information transmitted at high-resolution level.

For reasons of simplicity preferred MRM procedure is described in detail without repeating it in entirety for alternatives, as modifications according to those mentioned above would be obvious for anyone working within the field of technology.

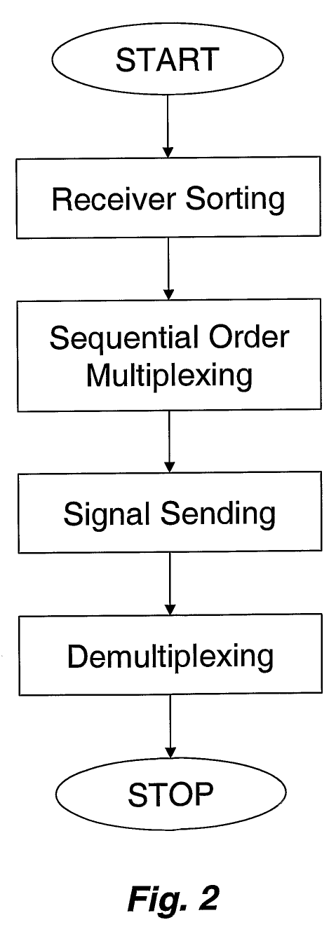

FIG. 2 illustrates a flow chart with basic functional processing steps of a method according to the invention.

First, in a transmitter station receiving data intended for one or more receiver stations, select a set of receiver stations based upon a predetermined condition and order the set of receiver stations according to path loss <<Receiver Sorting>>. For simplicity, the receiving station with greatest path loss is designated the first station, but any number being a range limit of a sequential numbering could be applied. Receiver stations with successively smaller path losses, if any, are numbered consecutively in ascending order. Equivalently, descending order could be selected as well with immediate modifications as regards counters.

Second, from the transmitter station traffic is multiplexed to the selected receiving stations by means of multi-resolution signal constellation in consecutive order, where the first station uses coarse MRM resolution and subsequently numbered stations uses successively same or finer resolution <<Sequential Order Multiplexing>>. Whether more than one user could be allocated identical MRM resolution levels depends on actual multiplexing or combinations of multiplexing methods.

Third, a composed signal is sent <<Signal Sending>>.

Fourth, the received signal is demodulated, decoded and demultiplexed <<Demultiplexing>>. Preferably, the received signal is demodulated, decoded and demultiplexed for consecutively increasing resolution levels, starting with coarsest resolution level and subsequently retrieving information of finer resolution levels.

Preferably, the processing steps of the method according to the invention also includes:
Indicating to the selected stations multiplexing structure and associated parameters. This would facilitate processing at the receiver. As a non-exclusive example, decoding level is indicated for the respective resolution levels. The receiver then stops decoding and demultiplexing at this resolution level.
Determining channel quality information parameters. The various receivers, e.g., report CQI (channel quality information) to the transmitter.

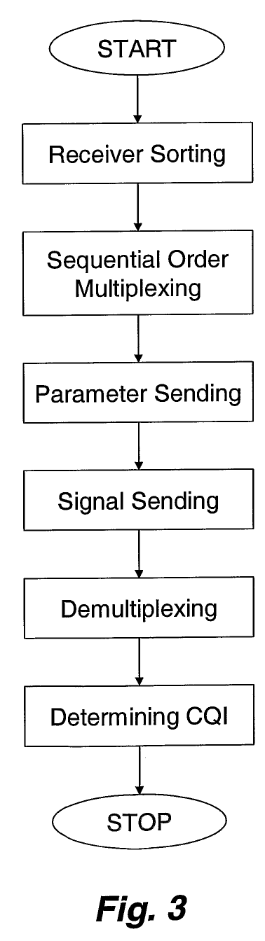

This additional processing is included in FIG. 3.

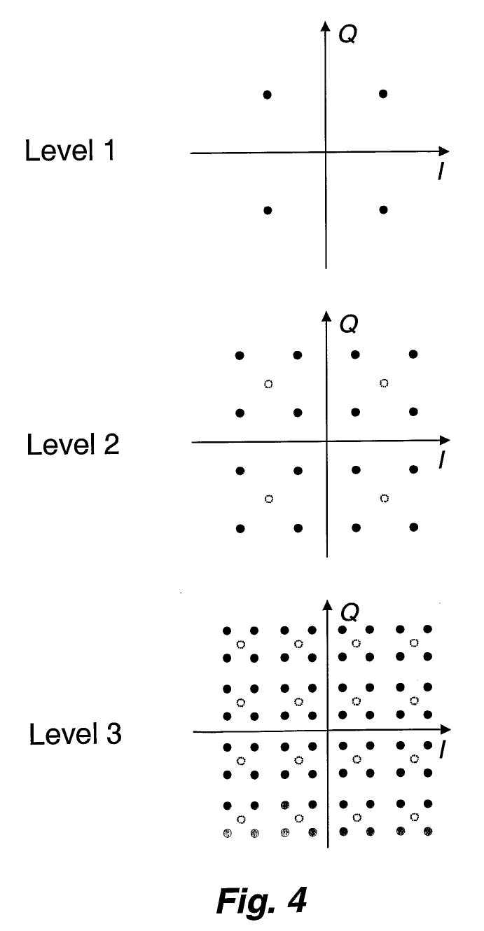

FIG. 4 illustrates a QAM (Quadrature Amplitude Modulation) multi-resolution signal constellation with three resolution levels. The figure illustrates in-phase, I, and quadri-phase, Q, signal components. At first resolution level <<Level 1>> only four signal alternatives, indicated in the figure by black bullets, are identified according to 4-QAM (or equivalently 4 QPSK). At second resolution level <<Level 2>> 16 signal alternatives are identified, and at third and finest resolution level <<Level 3>> all 64 signal alternatives can be identified. For reference the signal points of first level <<Level 1>> remain dashed at second level <<Level 2>>, and the signal points of second level <<Level 2>> remain dashed at third level <<Level 3>>.

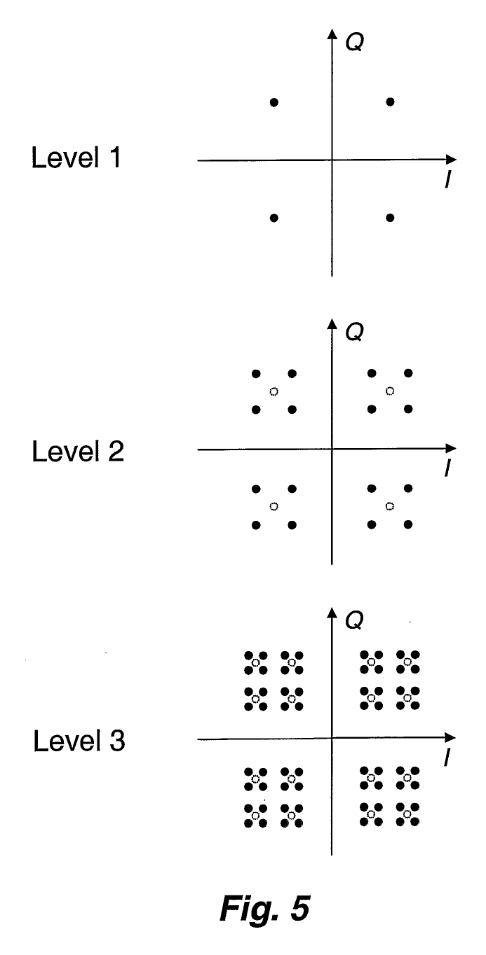

With a signal constellation with great symmetries, as the one illustrated in FIG. 4, performance is deteriorated quite substantially for low resolutions when higher resolution levels are superimposed. Consequently, users of lower resolution levels would experience substantially varying performance depending on whether users of higher levels are multiplexed onto the signal constellation. This impairment can be somewhat reduced and traded for performance of higher layer users by introducing different distances between various signal points thereby creating some clustering of signal points at various levels. A preferred signal constellation with such balanced asymmetries or clustering, for the same example number of levels and signal alternatives as in FIG. 4, is illustrated in FIG. 5.

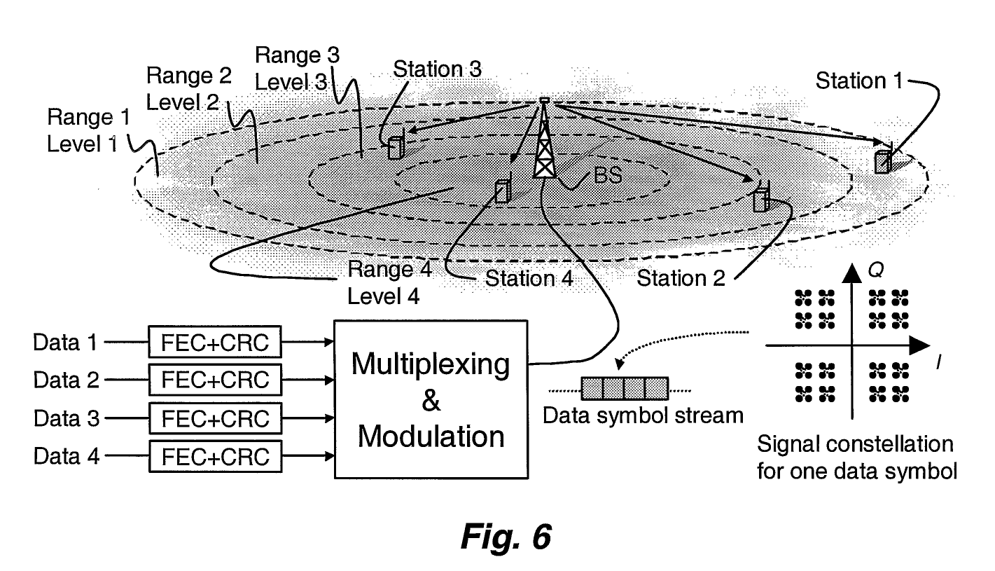

FIG. 6 illustrates a communications situation with a signal constellation similar to that of FIG. 5, but extended to four levels. Data <<Data Range 1>>, . . . , <<Data Range 4>> destined for receiver stations <<Station 1>>, . . . , <<Station 4>> classified into ranges depending on the respective path loss between transmitter station <<BS>> and receiver stations <<Station 1>>, . . . , <<Station 4>>. Signaling is transmitted from a base station <<BS>> after FEC (Forward Error Control) and CRC (Cyclic Redundancy Checking) coding <<FEC+CRC>>, multiplexing user data onto a multi-resolution level and modulation for that resolution level <<Multiplexing and Modulation>>. There are four different ranges corresponding to a simplified and quantized path loss pattern. In the outmost ring <<Range 1>> the simplified path loss is greatest, and consequently the immunity to noise and interference smallest, within the coverage of the transmitter station <<BS>>. Consequently, the coarsest resolution <<Level 1>> is used for this range <<Range 1>>. The range ring <<Range 2>> closest to the outmost ring comprises receiver stations of second greatest quantized path loss. Receiver stations <<Station 2>> within this range ring detects symbols at second level of the multi-resolution signal constellation. The range ring <<Range 3>> inside of the second range ring <<Range 2>> comprises receiver stations of third greatest quantized path loss. Data for receiver stations <<Station 3>> within the path-loss range of this ring <<Range 3>> are multiplexed and modulated according to a third level of the multi-resolution modulation signal constellation. Receiver stations <<Station 4>> in the innermost region <<Range 4>> closest to the transmitter station <<BS>> perceive the smallest quantized path loss and consequently has best immunity towards noise and interference. Data destined for receiver stations <<Station 4>> of this region <<Range 4>> is multiplexed and modulated on the finest level of the four-level multi-resolution modulation signal constellation. Consequently, receiver stations <<Station 4>> within this range <<Range 4>> can increase their data rate due to the superior channel quality in this region <<Range 4>>.

For reasons of backward-compatibility, receiver stations operating according to possibly former specifications with no or smaller number of resolution levels can be allowed if the system provides for information exchange between transmitter and receiver stations. Then receiver stations in, e.g., the innermost region can demodulate and demultiplex also received symbols, if they are multiplexed and modulated on a resolution level according to its specification. This provides for a second mode of the invention allowing signals to be multiplexed and modulated at a low resolution also in regions which, according to the path loss, would otherwise not be capable of demultiplexing and demodulating at such a high resolution level.

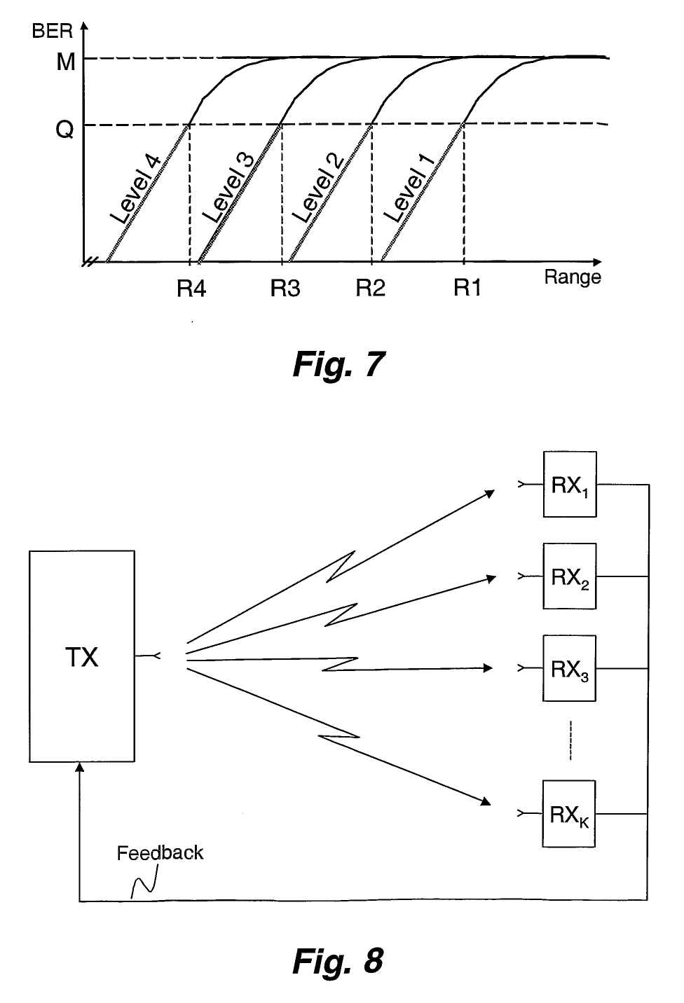

FIG. 7 illustrates schematically decoding performance in terms of bit error rate <<BER>> or block error rate, BLER, for various resolution levels <<Level 1>>, <<Level 2>>, <<Level 3>>, <<Level 4>>, versus distance between transmitter and receiver stations <<Range>>. The performance approaches asymptotically level <<M>>, which for most cases equals 0.5, when distance increases. For a specified quality level <<Q>> to be satisfied, e.g. 10⁻², there is a maximum respective communications range <<R>>, <<R2>>, <<R3>>, <<R4>> for the resolution levels <<Level 1>>, <<Level 2>>, <<Level 3>, <<Level 4>>. The exact ranges depend on propagation conditions resulting in path losses, often expressed in terms of path gain, particular modulation, intra-cell interference etc. With careful selection of selection of multi-resolution self interference, performance is deteriorated compared with what performance would be achieved with only one resolution level, as explained in relation to FIGS. 4 and 5. For small bit error rates (or block error rates) example range-differences between different resolution-levels at fix bit error rate are approximately 6-10 dB (or 2-3 times). Consequently, an example dynamic range of approximately 25-40 dB sustains multi-resolution multiplexing with four levels according to the invention. With a signal constellation similar to the one illustrated in FIG. 5 extended to four levels, this is achieved with a signal constellation of 256 signal points. Greater dynamic range sustains greater number of resolution levels and correspondingly greater signal constellations.

FIG. 8 schematically illustrates feedback of channel quality information, CQI, according to the invention. The feedback <<Feedback>> is preferably provided by entities <<RX₁>>, <<RX₂>>, <<RX₃>> . . . <<RX_{K}>> with established connections, pending traffic or associating with a transmitter <<TX>> to receive feedback information. Feedback information could also be transmitted continuously or on a regular basis.

A preferred channel quality information is signal to interference and noise ratio, SINR. The SINR is measured on a received signal, e.g. a pilot signal, transmitted by the transmitter <<TX>> to which transmitter the feedback is provided.

A second preferred channel quality information feedback comprises estimated propagation path gain/loss in addition to interference and noise levels. Interference and noise levels are either communicated through dedicated signaling or incorporated signaling e.g. by offsetting pilot signal transmit power.

Channel quality may also be determined by exploiting channel reciprocity in e.g. time division duplex communications within the coherence time.

Fast CQI feedback provides adaptive scheduling of transmissions in response to channel induced signal fading, also referred to as channel fading. The adaptive scheduling provides transmissions of multiple concurrent signals to multiple receivers.

In a preferred embodiment the transmitter schedules transmission to various users by optimizing an objective function ƒ. The optimization can be expressed in terms of an optimum value Z,

$$Z = {max}_{{ϕ ∈ Φ}_{\{ {MCS}_{ϕ} , {P}_{ϕ} \} ∈ Ψ}} \{ f ( {CQI}_{ϕ} , {MCS}_{ϕ} , {P}_{ϕ} , {P}_{tot} ) \} ,$$

where CQI₁₀₀, is channel quality information, MCS_{φ}, is the available modulation and coding schemes, P_{φ} is the power for data flow φ and Pₜₒₜ is the total transmit power. In a preferred embodiment maximization is conditioned on a fairness parameter for balancing aggregate instantaneous throughput and individual user throughput.

Φ is the set of data flows in the transmitter. Ψ denotes one or a multitude of transmit parameters, and consequently may be multidimensional. Each transmit parameter may be continuous or discrete. The parameters are, e.g., transmit power, modulation and coding, multiplexing order and optionally different receiver capabilities.

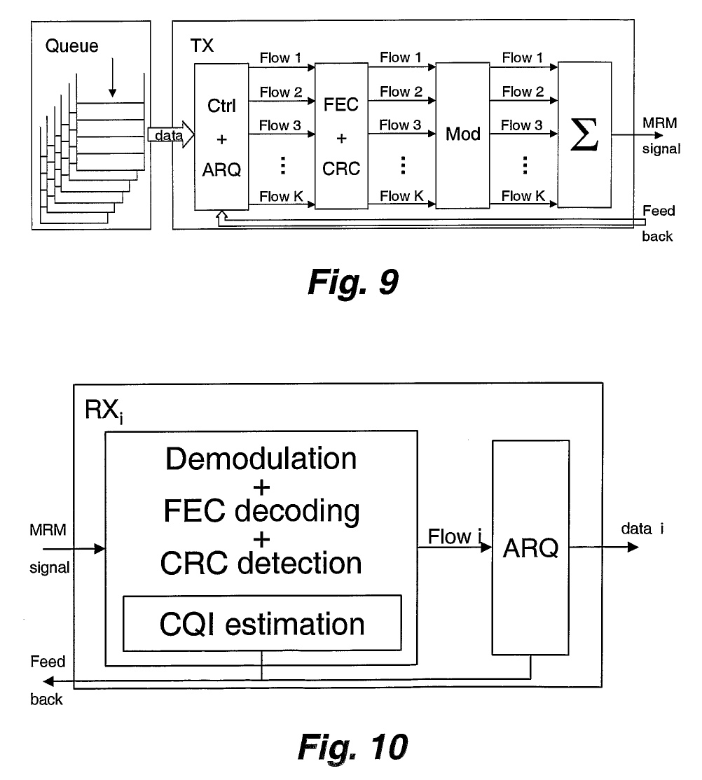

FIG. 9 illustrates transmitting side of system architecture for MRM with K data flows. In the transmitting entity <<TX>>, a control unit <<Ctrl & ARQ>> is responsible for determining transmission parameters, selection of data flow and retransmissions. Arriving data to be transmitted is segmented into protocol data units and buffered <<Queue>>. The buffering is preferably dedicated for each flow. Protocol data units, PDUs, of the different data flows <<Flow 1>>, <<Flow 2>>, . . . <<Flow K>> are forward error control, FEC, coded and a cyclic redundancy checking, CRC, check sum is added prior to transmission. The respective obtained symbol sequence of each data flow is modulated and multi-resolution multiplexed <<Modulation>>. Automatic repeat request <<ARQ>> provides for increased reliability. Feedback information <<Feedback>> received from various users or receivers is input to the control unit <<Ctrl & ARQ>>.

FIG. 10 illustrates receiving side of a system architecture of MRM for retrieving data of an i:th out of the K data flows illustrated in FIG. 9. Transmitted modulated data is received in a receiver. Modulated data is demodulated for its resolution level and decoded for error correaction and error detection. Channel quality information is estimated <<CQI estimation>> from the received signal and fed back to the transmitter <<TX>>, see FIG. 9. In the receiving entity <<RX>> received modulated data is decoded, preferably by iterative decoding <<Decoding & CRC>>, and CQI is estimated <<CQI estimation>>. The receiving entity <<RX>> comprises a retransmission unit <<ARQ>> responsible for acknowledging positively or negatively received data to its transmitting counterpart <<Ctrl & ARQ>> of the transmitting entity <<TX>> of FIG. 9. If error corrected received data of the i:th flow <<Flow i>> is detected to be erroneous it is negatively acknowledged or not positively acknowledged. If it is not detected to be erroneous it is positively acknowledged or not negatively acknowledged. Channel quality information and acknowledgements are fed back <<Feedback>> to the transmitter side, illustrated in FIG. 9.

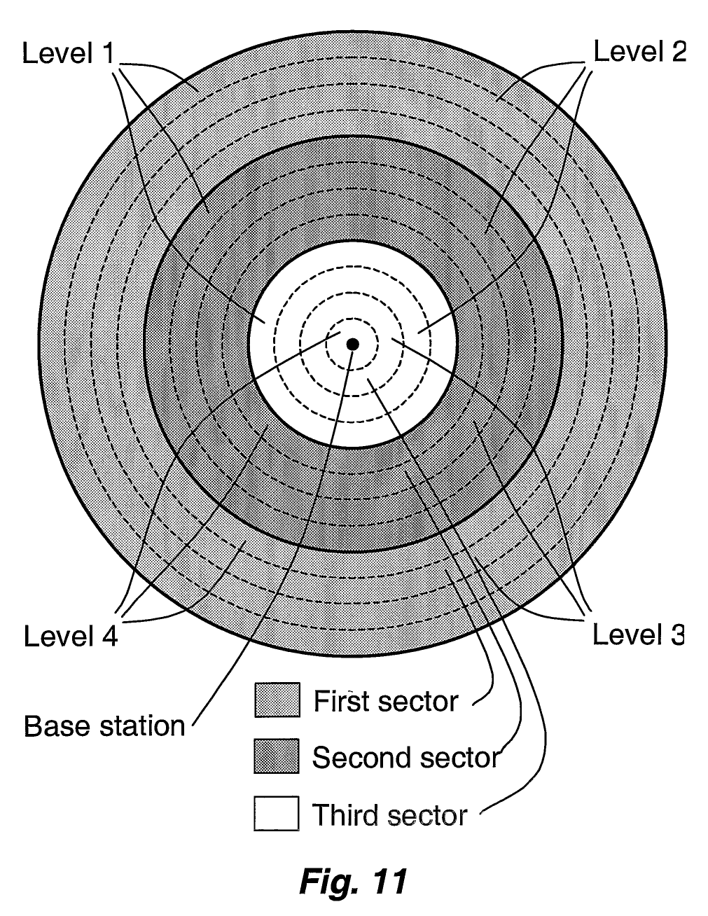

FIG. 11 illustrates a second embodiment of the invention. Radio coverage area is divided into two or more sectors <<first sector>>, <<second sector>>, <<third sector>> by orthogonal multiplexing technique, e.g. TDM (time division multiplex), FDM (frequency division multiplex) or CDM (code division multiplex). Resources of the sectors are allocated by means of TDMA (time division multiple access), FDMA (frequency division multiple access) and CDMA (code divisions multiple access), respectively. Within each sector multi-resolution multiplexing, MRM, is applied, as explained in relation to FIG. 6. The second embodiment is well adapted to, e.g., limited dynamic range handling in receiver and transmitter. Also, a greater number of flows compared to pure MRM can be distinguished and allocated channel resources.

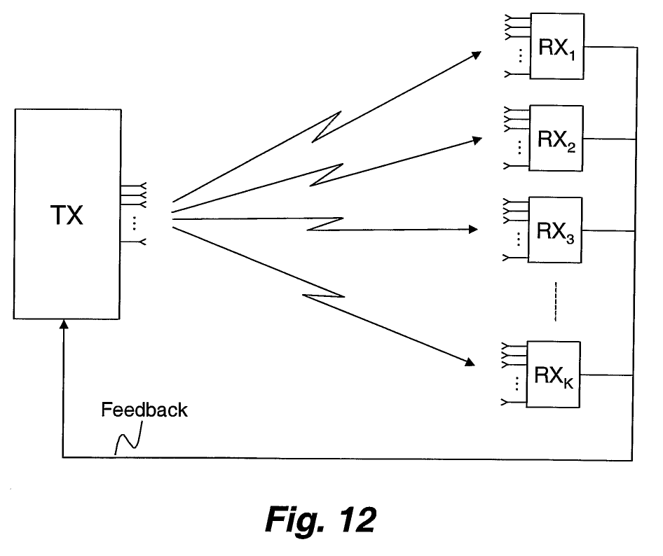

FIG. 12 illustrates an embodiment with multiple antennas on transmitter side, receiver side or both. The latter generally referred to as MIMO (‘Multiple Input Multiple Output’). In FIG. 12, there are K receivers <<RX₁>>, <<RX₂>>, . . . , <<RX_{K}>> illustrated. The respective number of receiver antennas may be identical or different for the receivers. For an example system with two receivers (K=2), the signals, R₁, R₂ received at the two receivers <<RX₁>>, <<RX₂>> respectively are

R₁=H₁(V₁S₁+V₂S₂)+W₁,

R₂=H₂(V₁S₁+V₂S₂)+W₂,

where H₁, H₂ are respective channel matrices for channels from transmitter to receiver <<RX₁>>, <<RX₂>>; V₁, V₂ represent weight matrices, weighting respective transmitted signals, represented as vectors S₁, S₂, destined for the receivers <<RX1>>, <<RX2>>. W₁ and W₂ are respective noise vectors at the receivers.

Weighting and coding rates for the respective signals are set based on the channel matrices and noise vectors. Preferably, the setting is determined jointly. In various modes of the embodiment various generalizations of multi user detection, MUD, are used, such as MMSE (‘Minimum Mean Square Error’), ZF (‘Zero forcing’), PIC (‘Parallel Interference Cancellation’) or SIC (‘Serial Interference Cancellation’) that are all generally less complex than maximum likelihood, ML, detection also used in a mode of the invention.

The invention is not intended to be limited only to the embodiments described in detail above. Changes and modifications may be made without departing from the invention. It covers all modifications within the scope of the following claims.

1. A method of communications multiplexing, the communications comprising modulated signals propagating from one or more transmitters to one or more receivers, of various user data flows, the method characterized in that
communications are allocated to various resolution levels of signal modulation depending on propagation conditions including instantaneous channel quality, and that
two or more communication data flows are scheduled for particular resolution levels of the signal modulation in order to optimize for the two or more communication data flows an objective function given total transmit power, modulation and coding scheme, and at least one transmission parameter.

2. The method according to claim 1 characterized in that a particular user is allocated to a particular resolution level depending on time-averaged channel quality information.

3. The method according to claim 1 characterized in that a particular user is allocated to a particular resolution level depending on instantaneous channel quality information of a channel subject to fading.

4. The method according to claim 1 characterized in that a signal constellation of the signal modulation is partitioned such that intra-subset distances decreases for increased resolution levels or levels of finer resolution.

5. The method according to claim 1 characterized in that communication data flows are scheduled for particular resolution levels optimizing an objective function with respect to at least one of
the various data flows, and
various transmission parameters; given total transmit power; modulation and coding scheme and at least one transmission parameter.

6. The method according to claim 5 characterized in that channel quality information is a parameter.

7. The method according to claim 6 characterized in that the channel quality information parameter depends on signal to interference and noise ratio or that signal to interference and noise ratio is a parameter.

8. The method according to claim 6 characterized in that the channel quality information parameter depends on channel gain or attenuation, or that channel gain or attenuation is a parameter.

9. The method according to claim 1 characterized in that radio coverage area of one transmitting site is divided into two or more transmission sectors.

10. The method according to claim 9 characterized in that the two or more transmission sectors are achieved by means of at least one of
time division multiplex,
frequency division multiplex, and
code division multiplex.

11. The method according to claim 1 characterized in that a received signal is decoded by serial or successive interference cancellation.

12. The method according to claim 11 characterized in that a received signal is decoded successively decoding starting with resolution level of coarsest resolution and ending with resolution level of finest resolution successively canceling interference of decoded resolution level.

13. The method according to claim 1 characterized in that a received signal is decoded by parallel interference cancellation.

14. The method according to claim 1 characterized in that a received signal is decoded with respect to an optimizing criterion being minimum mean square error, MMSE, zero forcing, ZF, or maximum likelihood, ML.

15. The method according to claim 1 characterized in that allocation resolution level is determined depending on signal propagation path loss between transmitter and receiver.

16. The method according to claim 1 characterized in that signal propagation parameters are stored at the transmitter side for various user data flows.

17. The method according to claim 1 characterized in that receivers are sorted according to the respective signal propagation path losses from the transmitter to the receivers.

18. The method according to claim 17 characterized in that respective receivers are allocated such that receivers with greater signal propagation path loss are allocated a smaller resolution level or signal subset of finer resolution and receivers with smaller signal propagation path loss are allocated a greater resolution level or signal subset of coarser resolution.

19. The method according to claim 1 characterized in that a signal with signal symbols composed of multiplexed user data is transmitted by the transmitter.

20. The method according to claim 1 characterized in that signal constellation of the signal modulation comprises balanced asymmetries between resolution levels.

21. The method according to claim 1 characterized in that the signal modulation of multiple resolution levels comprises 2, 3 or 4 resolution levels.

22. The method according to claim 1 characterized in that at least one of transmitter side and receiver side implements multiple antenna communications for one or more communication links.

23. The method according to claim 22 characterized in that weighting of signals transmitted from transmitter side or received at receiver side optimizes received signal quality in accordance with at least one of the principles of
minimum mean square error, MMSE,
zero forcing, ZF,
maximum likelihood, ML,
parallel interference cancellation, PIC, and
serial interference cancellation, SIC.

24. Radio communications equipment for communications multiplexing, the communications comprising modulated signals propagating from one or more transmitters to one or more receivers for various user data flows, the radio communications equipment characterized by
processing and modulation means allocating communications to various resolution levels of signal modulation depending on propagation conditions including instantaneous channel quality, and by
processing means for scheduling communication data flows for particular resolution levels of the signal modulation, in order to optimize for the two or more communication data flows an objective function given total transmit power, modulation and coding scheme, and at least one transmission parameter.

25. The equipment according to claim 24 characterized by the processing means determining a channel quality time average and allocating a user to a particular resolution level depending on average channel quality information.

26. The method according to claim 24 characterized by the processing means determining an instantaneous channel quality of a channel subject to fading and allocating a particular user to a particular resolution level depending on instantaneous channel quality information.

27. The equipment according to claim 24 characterized by the processing and modulation means operating with a signal constellation of the signal modulation partitioned such that intra-subset distances decreases for increased resolution levels or levels of finer resolution.

28. The equipment according to claim 24 characterized by the processing means scheduling communication data flows for particular resolution levels optimizing an objective function with respect to at least one of
the various data flows, and
various transmission parameters; given total transmit power; modulation and coding scheme and at least one transmission parameter.

29. The equipment according to claim 28 characterized in that channel quality information is a parameter.

30. The equipment according to claim 29 characterized in that the channel quality information parameter depends on signal to interference and noise ratio or that signal to interference and noise ratio is a parameter.

31. The equipment according to claim 29 characterized in that the channel quality information parameter depends on channel gain or attenuation, or that channel gain or attenuation is a parameter.

32. The equipment according to claim 24 characterized in that a signal constellation of the signal modulation is partitioned such that intra-subset distances decreases for increased resolution levels or levels of finer resolution.

33. The equipment according to claim 24 characterized in that radio coverage area of one transmitting site is divided into two or more transmission sectors.

34. The equipment according to claim 33 characterized in that the two or more transmission sectors are achieved by means of at least one of
time division multiplex,
frequency division multiplex, and
code division multiplex.

35. The equipment according to claim 24 characterized by a decoder decoding received signal by serial or successive interference cancellation.

36. The equipment according to claim 35 characterized in that a received signal is decoded successively decoding starting with resolution level of coarsest resolution and ending with resolution level of finest resolution successively canceling interference of decoded resolution level.

37. The equipment according to claim 24 characterized by a decoder decoding received signal by parallel interference cancellation.

38. The equipment according to claim 24 characterized by the decoder decoding received signal with respect to an optimizing criterion being minimum mean square error, MMSE, zero forcing, ZF, or maximum likelihood, ML.

39. The equipment according to claim 24 characterized in that allocation resolution level is determined depending on signal propagation path loss between transmitter and receiver.

40. The equipment according to claim 24 characterized by storage means for storing of signal propagation parameters at the transmitter side for various user data flows.

41. The equipment according to claim 24 characterized by the processing means sorting receivers according to the respective signal propagation path losses from the transmitter to the receivers at transmitter side.

42. The equipment according to claim 41 characterized by the processing means allocating respective receivers such that receivers with greater signal propagation path loss are allocated a smaller resolution level or signal subset of finer resolution and receivers with smaller signal propagation path loss are allocated a greater resolution level or signal subset of coarser resolution.

43. The equipment according to claim 24 characterized by the equipment transmitting a signal with signal symbols composed of multiplexed user data.

44. The equipment according to claim 24 characterized in that signal constellation of the signal modulation comprises balanced asymmetries between resolution levels.

45. The equipment according to claim 24 characterized in that the signal modulation of multiple resolution levels comprises 2, 3 or 4 resolution levels.

46. The equipment according to claim 24 characterized by the equipment at transmitter side implements multiple antenna communications for one or more communication links.

47. The equipment according to claim 46 characterized by the processing means weighting of signals transmitted from transmitter side antennas or received at receiver side antennas optimizes received signal quality in accordance with at least one of the principles of
minimum mean square error, MMSE,
zero forcing, ZF,
maximum likelihood, ML,
parallel interference cancellation, PIC, and
serial interference cancellation, SIC.

48. The equipment according to claim 24 characterized by the equipment at receiver side implements multiple antenna communications for one or more communication links.

49. The equipment according to claim 48 characterized by the processing means weighting of signals transmitted from transmitter side antennas or received at receiver side antennas optimizes received signal quality in accordance with at least one of the principles of
minimum mean square error, MMSE,
zero forcing, ZF,
maximum likelihood, ML,
parallel interference cancellation, PIC, and
serial interference cancellation, SIC.

50. A radio communications system comprising transmitting entities and receiving entities characterized by the radio communications system comprising means for carrying out the method in claim 1.
